(19) United States
(12) Patent Application Publication
(10) Pub. No.: US 2023/0349370 A1
(43) Pub. Date: Nov. 2, 2023

(54) PRESSURE WASHER APPARATUS

(71) Applicant: 7RDD Limited, Yorkshire (GB)

(72) Inventors: RIENTS BAKKER, Yorkshire (GB); ALDO TIEFENTHALER, Yorkshire (GB)

(21) Appl. No.: 17/753,925

(22) PCT Filed: Sep. 18, 2020
(86) PCT No.: PCT/GB2020/052272

§ 371 Date: Mar. 18, 2022

(30) Foreign Application Priority Data
Sep. 18, 2019 (GB) 1913470.9
Oct. 16, 2019 (GB) 1914968.1
Apr. 6, 2020 (GB) 2005061.3

(51) Int. Cl. F04B 1/053; B08B 3/02; F04B 1/0452; F04B 17/03

(52) U.S. Cl. CPC F04B 1/053; B08B 3/02; F04B 1/0452; F04B 17/03

(57) ABSTRACT

The present invention relates to hand held apparatus which is for use in the provision of a supply of a liquid, such as water, which is emitted from the apparatus at a pressure which is greater than that at which it enters the apparatus and which apparatus is commonly referred to as a pressure washer. The invention is particularly, although not solely, related to the provision of the apparatus with a power supply which is mounted on the same and therefore renders the apparatus completely portable and the apparatus is provided with a pump, operating control means and features which allow a greater pressure of the liquid that is emitted to be achieved than is possible with conventional battery powered pressure water apparatus.

The invention to which this application relates is to apparatus of a type commonly known as a pressure washer and which typically is connected to a source of liquid supply, including water, such as, for example, a mains connected hosepipe, a housing with an input to which the water supply is connected, a pump provided within the housing and in connection with the water source so as to pump the water through the housing towards an output so that the water which leaves the output is at a higher pressure than that at which enters the housing. Typically, the pressure of the water which leaves the housing is sufficient to allow the water to be directed towards an article or surface to provide a cleaning or washing effect on the same.

Conventionally, the pump in the housing is operated by a motor provided with electrical power from a mains power source such as a plug connection via a cable and, while this conventionally allows a relatively powerful pump to be utilised and therefore a relatively high pressure of water to be output, the need for a cable connection from the socket to the housing, does limit the range of use of the apparatus and eliminates the possibility of using the apparatus where a mains electric supply is not available. As a result, while there are a large number of uses to which the apparatus could usefully be put these cannot be achieved using mains power operated pressure washer apparatus.

More recently, it has been possible to purchase apparatus which utilises a power source in the form of one or more battery packs which are mechanically and electrically connected to the housing and which therefore allow the power supply to be portable and, as a result, the pressure washer apparatus as a whole to be portable, so that the same can be used in connection with a water supply hosepipe as previously or, alternatively, with a portable water supply such as a container and therefore the apparatus as a whole becomes useable in any location or environment and a wider range of possible uses of the apparatus becomes available.

However, in practice, it is found that the limitations of the conventional pump design and/or the level of power which can be generated from the battery pack, means that the pressure of the water which leaves the apparatus housing is relatively low compared to the mains power operated apparatus and, in certain circumstances, it can be so low as to render the apparatus of little practical use in terms of the washing effect which is created. Furthermore, the weight and balance of the apparatus of this type, can make the use of the apparatus relatively clumsy and tiring for the user so that, while there are benefits of the portability of the apparatus of this type, the disadvantages mean that the practical usage of the apparatus still remains limited.

In all forms of the apparatus there is a need to be able to prevent the water from the water supply passing through the apparatus when the motor and pump are not operable. If prevention means are not provided the water supply passes through the apparatus and leaves the same through the output which can cause spillage, is wasteful of the water and can make it difficult for the apparatus to be correctly and safely set up if water continues to pour through the apparatus in an uncontrolled manner.

It is known to provide means to prevent the passage of water through the apparatus by providing a check valve assembly which can be located in the flow path of the water between the input and the output of the housing and for the check valve to be retained in a normally closed position so as to prevent water which enters the apparatus at the input, from reaching the output. One means by which this can be achieved is to provide the check valve with biasing means which retain the check valve in a closed position until the pressure of the water upstream of the check valve reaches a sufficient level so as to move the biasing means to an opened position and thereby allow the water to flow through the valve and to the output. However, a problem with this form of check valve is that it can be found that the pressure level which is required to be reached before the biasing means is moved, and hence the check valve opened, is too great for repeated reliable operation to be achieved.

A further known manner by which the check valve can be operated, is to position a switch for operation of the pump and motor by connecting the power supply such that when it is moved to a start position to cause electrical connection and operate the motor and pump, the same switch operation is also used to move the valve seat of the check valve from a closed position to an open position and thereby allow the flow of water to the pump. This therefore means that the operation of the check valve to the open position and the said electrical switch, to operate the motor and pump occurs simultaneously.

The problem with this is that it means that the switch, typically a user greppable, trigger lever located at the handle of the housing has to be relatively large so as to allow both operating requirements to be achieved by different portions of the lever when it is moved to the start position and, a further problem is that if there is a problem with the operation of the lever, or part of the lever breaks or does not move, then one or the other of the valve or the electrical switch may not be operated so that, for example, if the valve is not operated then the motor and pump will run with no water passing therethrough and therefore may overheat or fail or, if the check valve is operated and the switch is not operated, then the water supply will flow through the apparatus in an uncontrolled manner.

An aim of the present invention is to provide pressure washer apparatus in a form which is portable whilst, at the same time, allowing the pressure of liquid which leaves the apparatus to be sufficiently high so as to create a beneficial cleaning effect.

A further aim of the present invention is therefore to provide a means of allowing the provision of a check valve within the housing of the apparatus and for the operation of the check valve to be reliably achieved.

In a first aspect of the invention there is provided pressure washer apparatus, said apparatus including an input for connection to a source of a liquid, an output from which the said liquid leaves the apparatus, when operating, at a pressure greater than that which it enters the apparatus, a power supply to the said apparatus to operate a motor and in turn operate a pump, said pump located intermediate the said input and output and through which the liquid passes and wherein said pump includes a plurality of pump assemblies which are angularly offset about a drive axis.

In one embodiment, each of the assemblies includes a plunger mechanism provided for linear movement along an axis.

In one embodiment, each assembly includes an inlet valve and an outlet valve so as to allow liquid to enter and leave the assembly. In one embodiment the inlet and/or outlet valves are check valves.

Typically, the liquid which enters the respective inlet valves does so from a common chamber which is filled with liquid from the said input.

Typically, the liquid which leaves the outlet of each assembly, is combined downstream of the outlets, typically into a common chamber, and then passes to the output of the apparatus.

In one embodiment, there is provided a rotatable shaft mounted along a substantially, central axis and a member including a guide track is provided which has a centre which is offset to the said axis and about which axis the member rotates so as to move the said plunger mechanisms of the respective assemblies in a sequential manner.

Typically, the said shaft mounted along said axis is driven to rotate by a motor provided in the housing and said motor is connected to the said power supply.

In one embodiment, the motor, pump, input and output, are all located within a common housing.

In one embodiment, the said housing includes at least one power supply means connected therewith.

In one embodiment, the said power supply means are one or more battery packs selectively locatable with the housing and carried thereby during operation of the apparatus.

In one embodiment, the said one or more battery packs can be recharged and when a charge is provided, power is supplied to operate the apparatus therefrom. In one embodiment the battery pack slides into the housing containing the pump, switch and motor and is sealed with a waterproof cover.

In an alternative embodiment, the power supply may be provided via a cable connection from a mains electric supply.

In one embodiment, the liquid is water or water combined with a detergent or other cleaning agent.

In one embodiment the source of the water supply is a tap connection via which water passes to the input from a hosepipe.

In an alternative embodiment, the source of the water supply is a container in which the liquid is held and means are provided to allow water to be passed from the said container to the input of the housing.

In one embodiment in addition to the water source there is provided a source for a further liquid such as a detergent, which allows the liquid to be added to the water.

In one embodiment, the pump and housing includes an inlet chamber and an outlet chamber, a central chamber communicating the inlet chamber and the outlet chamber, a plurality of assemblies, each assembly including an inlet valve connected to the inlet chamber, an outlet valve connected to the outlet chamber, and a plunger mechanism intermediate the inlet and outlet valves; a shaft is driven by a motor and has located thereon an eccentric member with an eccentrically mounted rotating track, and the plunger mechanisms are positioned in a radially, angularly spaced configuration in the central chamber and the eccentrically mounted rotating track moves the plunger mechanisms individually and in sequence and the eccentric mounted track member returns the plunger mechanisms individually and in sequence via bearings located with the track.

In one embodiment, the said outlet valves are driven by the eccentric moving centre shaft and the respective plunger mechanism while the inlet check valves are driven by the respective plunger mechanism and an eccentric moving cup of the said track.

In one embodiment, the eccentric member includes a rotary shaft rotatable about an axis and an eccentric shaft connected to the rotary shaft with the eccentric shaft provided as part of the said track and cup and in contact with the plurality of plunger mechanisms radially positioned around the central shaft.

In one embodiment, the said plunger mechanisms are provided with a bearing located in the track of the eccentric member.

In one embodiment, the plunger mechanisms consist of at least two different materials in order to adjust the weight of the plunger mechanisms to reduce overall vibration of the apparatus in use.

In one embodiment, in each sequence of operation the plungers return to a cycle start position without requiring the influence of springs so as to return the plunger mechanisms to drive the inlet check valves.

In one embodiment, the shaft and the motor do not need to operate at the same speed as the eccentric member of the pump.

In one embodiment, the outlet chamber is connected to a pressure valve which prevents water from flowing when the pump is not activated.

In one embodiment, the motor which drives the central shaft of the pump can operate at different speeds and therefore is used to regulate the pressure and the liquid flow in the outlet chamber.

In one embodiment, the pump assembly is suspended within the housing so as to reduce vibration of the apparatus when in use.

In one embodiment, the input chamber and output chamber are positioned on the same side of the pump.

In one embodiment, the plunger assemblies are in contact with the eccentric member track via one or more rotatable bearings and each plunger mechanism is provided with a contact surface, such as a slot, connected with the eccentric moving cup of the eccentric member.

In one embodiment, there is provided a liquid passage intermediate the motor and pump which allows the supply of liquid from the input to provide a cooling effect on the motor.

It is envisaged that the apparatus as herein described will be capable of being operated to generate a liquid output at a pressure within a relatively wide range and typically at a greater pressure than is currently possible with portable pressure washer apparatus which typically operates at below 20 Bar pressure. In contrast, in the current invention the liquid output can be at a pressure above 25 Bar which allows the same to be used for applications which cannot be achieved using conventional portable apparatus. Indeed it is envisaged that the liquid output pressure could be up to 75 Bar and indeed greater and, this is in conjunction with the possibility of allowing continued operation of the apparatus for a significant period of time, such as more than 96 hours and for the same to be submergible and still be operational, allows the same to meet safety standards which allow additional possible uses of the apparatus.

In one embodiment, there is provided apparatus for the provision of a liquid to be output therefrom at a higher pressure than that at which the same enters the apparatus, said apparatus including a motor and pump to allow the pressurisation of the liquid supplied to the apparatus, said pump located in the flow path of the said liquid between an input and an output, said apparatus including a user actuable means to allow the change of the apparatus between on and off conditions and wherein at least one check valve assembly is provided in the flow path of the liquid between the input and the output and wherein the operation of the check valve assembly between a closed and open condition is achieved by the movement of control means between first and second positions by the user.

Typically, the operation of the control means, can be achieved independently of the movement of the said user actuable means which in one embodiment is in a lever or push button form.

Typically, the control means are connected to a member of the check valve assembly which is located so as to exert a movement force on a valve seat of the check valve and thereby allow the same to be moved from a first, closed position to a second open position when the control means is moved to the second position.

In one embodiment, the check valve includes biasing means which, when the control means is moved from the said position which causes the valve seat to be moved to an open position, cause the valve seat to be returned to a closed position automatically and without the need for user actuation of the control means.

In one embodiment, the valve seat and control means are arranged so that the valve seat is moved to the open position when the control means is moved to a first position in which the same also acts to lock the user actuation means. Thus, when the user actuable means is locked by the control means, so the check valve is in a closed position and when the user actuation means is released so as to operate a switch to move to an on position the check valve is moved to an open position to allow the flow of water through the apparatus and, with the user actuation means being in the on position, so the motor and pump are operated to pressurise the said liquid before it leaves the output.

In one embodiment, the operation of the control means is in a linear direction and in one embodiment, the axis along which the control means is moved, is perpendicular to the pivotal axis for movement of the said user actuation means.

Typically, the control means includes a portion which is located with respect to the handle so that when the same is moved to a locking position, the user actuation means is retained in a position.

Thus, in accordance with the invention, there is provided a check valve assembly for allowing the selective control of the passage of liquid through the apparatus and to prevent the passage of the liquid when the motor and pump of the apparatus are not operated and thereby prevent the passage of unpressurised liquid through the apparatus. Furthermore, the invention is achieved independently of the user actuation means of the apparatus.

Specific examples of the invention are now described with reference to the accompanying drawings wherein:

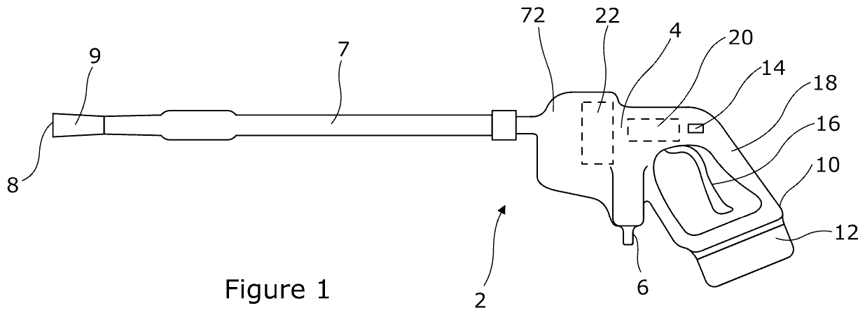

FIG. 1 illustrates apparatus in accordance with one embodiment of the invention;

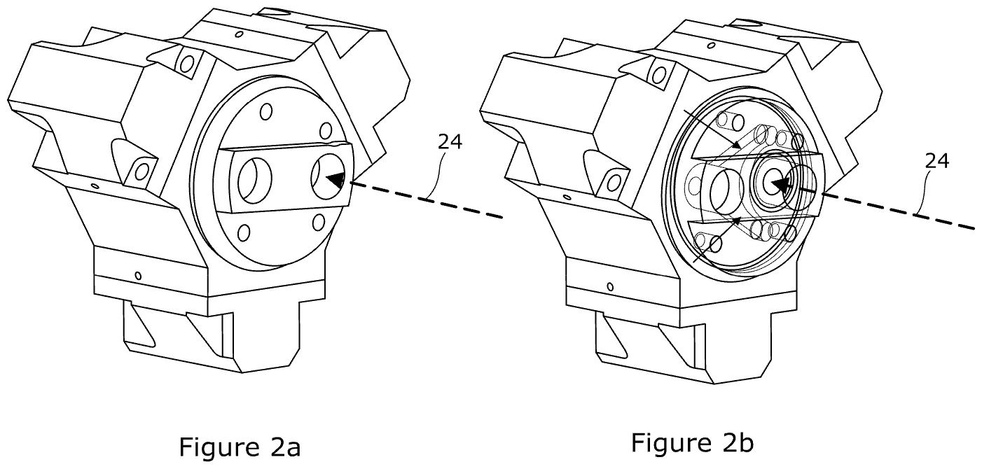

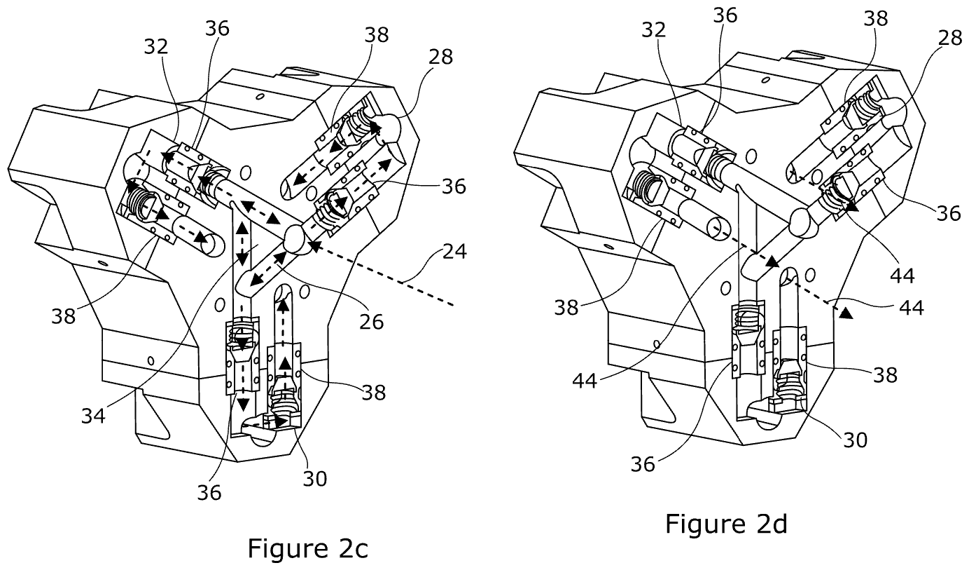

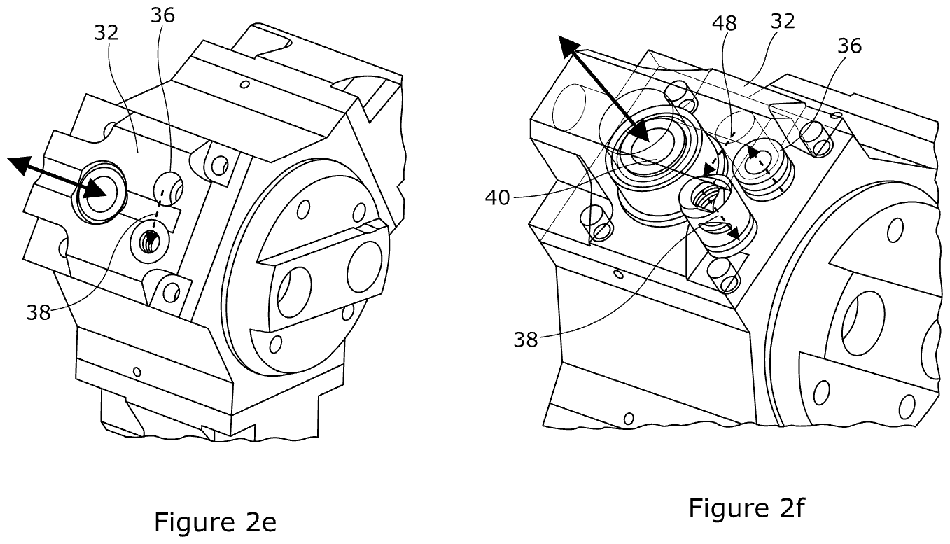

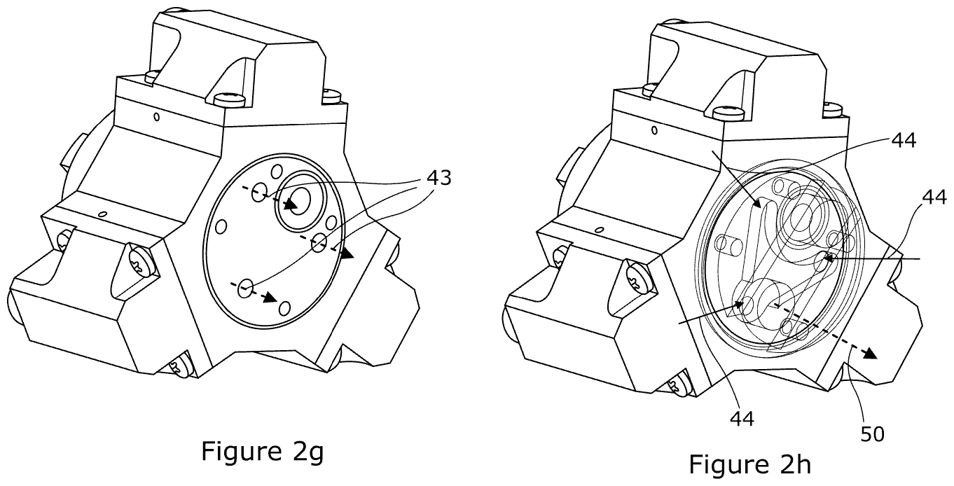

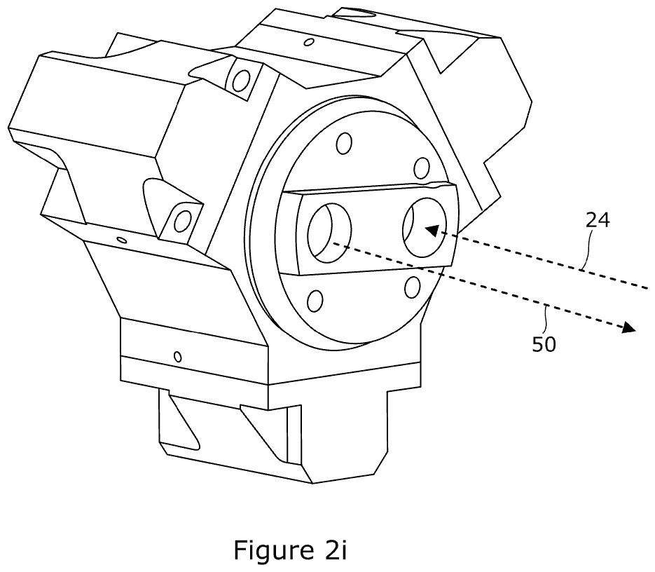

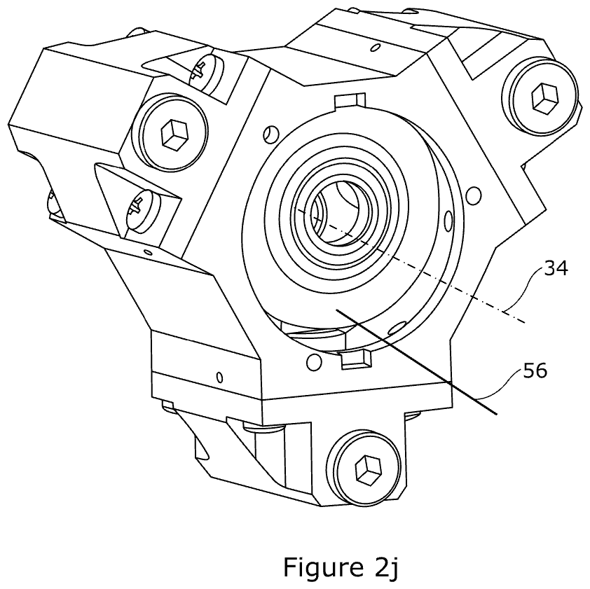

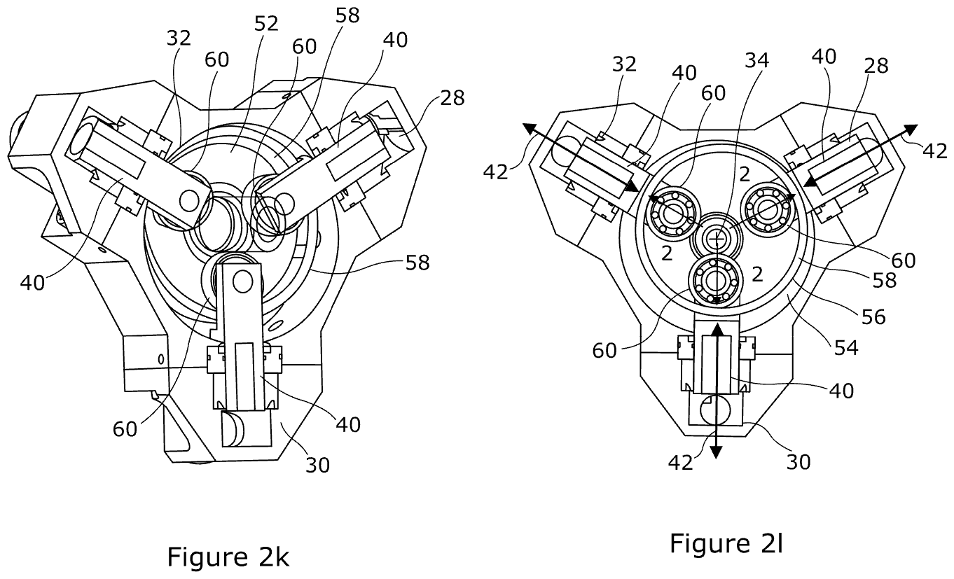

FIGS. 2a-l illustrate the stages of operation of a pump provided with apparatus in accordance with one embodiment of the invention;

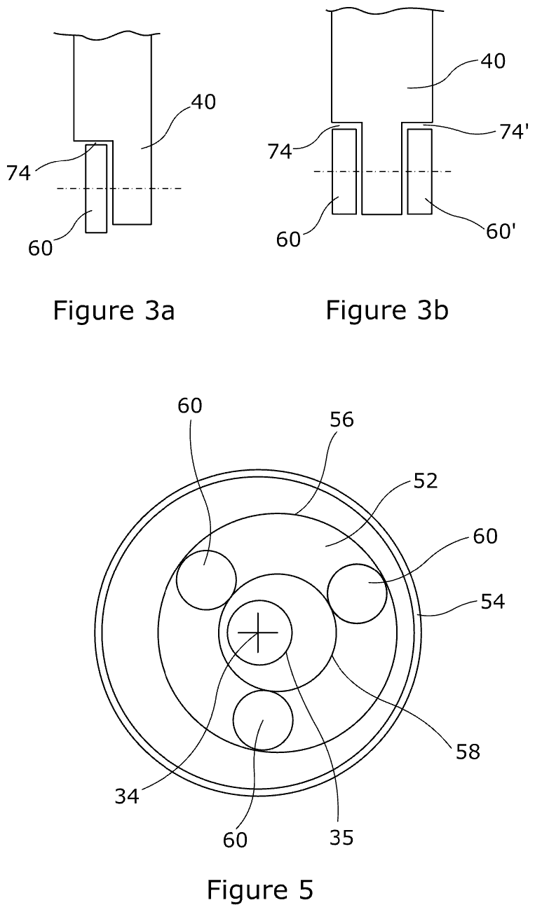

FIGS. 3a and b illustrate two embodiments of the provision of bearings for the plunger mechanisms;

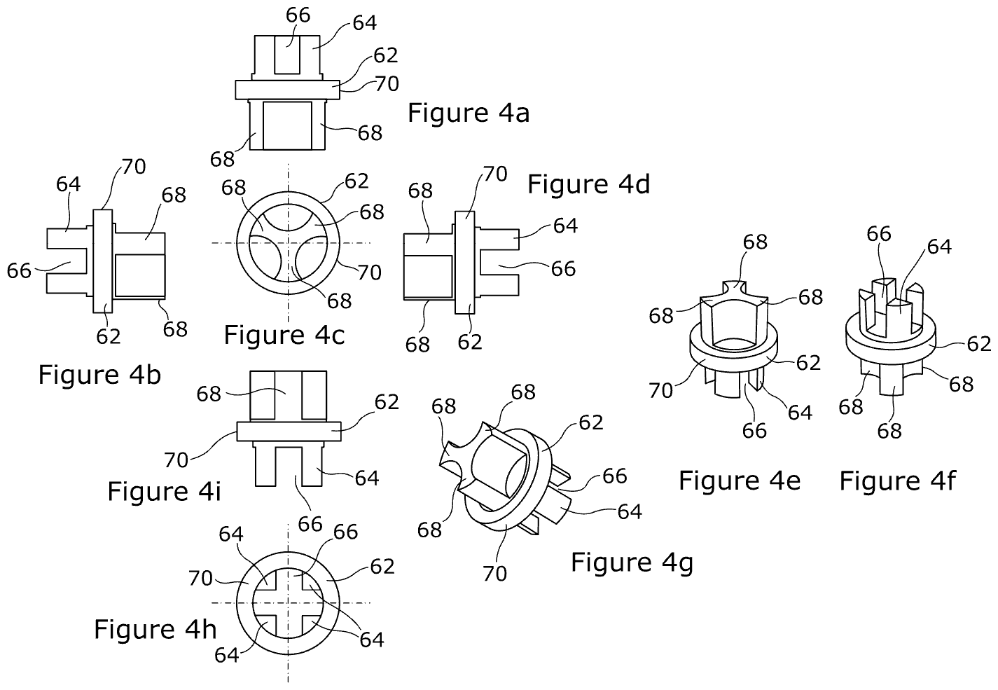

FIGS. 4a-i illustrates a shuttle member of the check valves in one embodiment;

FIG. 5 illustrates schematically the relationship between the motor shaft, the pump housing and the rotatable pump components.

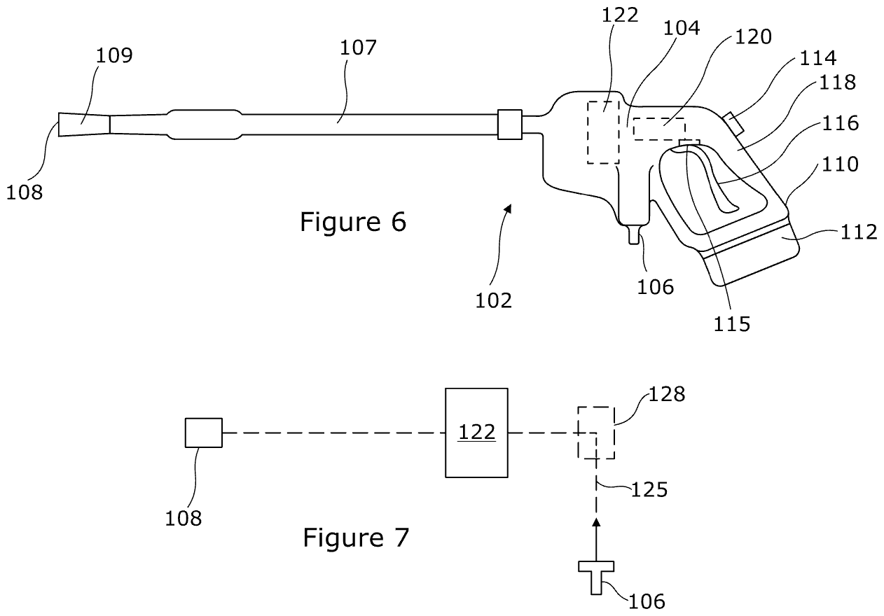

FIG. 6 illustrates a pressure washer apparatus in accordance with one embodiment of the invention;

FIG. 7 illustrates in a schematic manner, the flow path of the liquid through the apparatus of FIG. 1;

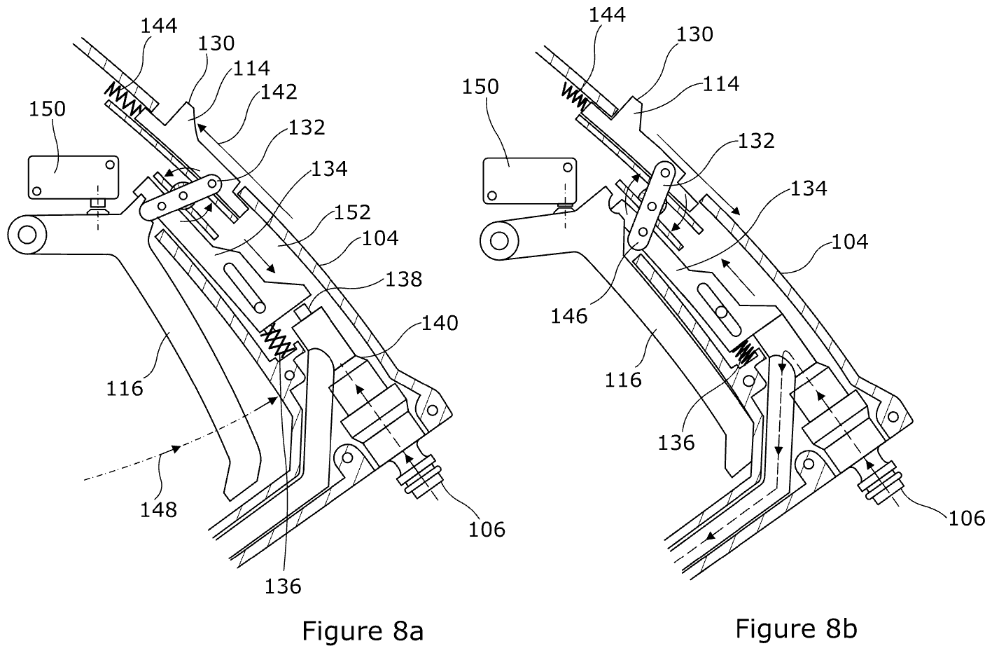

FIGS. 8a and b illustrate a check valve locking means assembly in accordance with one embodiment of the invention; and

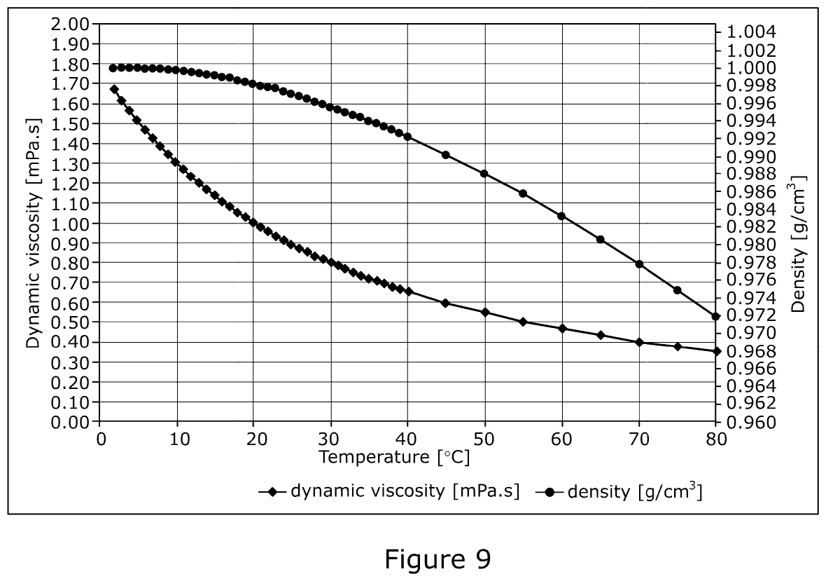

FIG. 9 illustrates the manner in which the dynamic viscosity and density of water changes with respect to changes in temperature.

Referring now to FIG. 1, there is illustrated apparatus in accordance with an embodiment of the invention in which the same is provided as a portable pressure washer apparatus 2. The apparatus comprises a housing 4 which has an input 6 and leads to a lance portion 7 which has an output 8. The input 6 is provided to be connected to a source of liquid such as water and, in this embodiment, the connection with the source is via a standard hosepipe connection but it should be appreciated that other forms of input can be provided to suit the particular source from which the water is provided. For example, rather than a hosepipe being the source via which mains water is delivered to the apparatus, the water may be provided in a container fitted to the housing 4 and or is connected to the housing by a pipe to allow water to be drawn from the container and into the input 6.

At the output 8, there may be provided means 9 to allow the user to adjust the particular form in which the liquid is output such as, for example, a selection can be made between providing the output of the water in the form of a spray, a single stream or variations of the same.

Also provided in the housing are mechanical engagement means 10 which are provided to allow the mechanical engagement with the housing of a battery pack 12 as shown. The battery pack can be of any appropriate form and, is provided with, typically in a conventional manner, a series of terminals which, when the battery pack is mechanically engaged with the housing, electrical contact is made with terminals provided on the housing.

When the power cells and the battery pack are charged and the battery pack is mechanically connected to the housing, so power for operation of the apparatus is provided from the battery pack. Also provided on the housing are switching means 14 to allow the switching on and off of the apparatus as appropriate and this allows the generation of the output of water at a higher pressure than that at which it enters the apparatus. In order to allow the water to exit the output 8, the user operates a trigger switch 16 which is selectively operable by the user so as to allow the output of water under pressure and the user can grip the housing via the handle 18 and then direct the output of water towards a particular article or surface so as, for example, to perform a cleaning operation on the same.

Within the housing, there is provided a motor 20 shown in broken lines which is connected to the power source and which operates so as to allow the operation of a pump 22 also provided within the housing and again shown in broken lines. The pump, when operated by the motor, allows the movement of water from the input 6 to the output 8 and when passing through the pump located intermediate those two locations, the pressure of the water is increased. Some or all of the water which enters the apparatus from the input 6, may be directed in a path around the motor 20 so as to create a cooling effect on the motor as it operates.

Turning now to FIGS. 2a-l, there is illustrated the steps of operation of the pump of the apparatus, in accordance with one embodiment of the invention.

It will be shown that from the input of the apparatus, the water is passed, as indicated by arrow 24 into the pump as shown in FIGS. 2a-c and the pump provides a suction effect to draw the water from the supply into the assemblies as the pump cover is sealed from the external environment in the housing and the inlet is sealed off from the external environment and from the internal pump chamber 26. In the pump chamber 26, in this embodiment, there are provided three pump assemblies 28, 30,32 which are radially located around a centre axis 34 which typically, runs along the same axis as that of the rotational shaft 35 of the motor and, on which, movement control means for the three pump assemblies are mounted. It should be appreciated that in other embodiments. Each pump assembly 28,30, 32 includes an inlet check valve 36, and a connected outlet check valve 38 and which, in combination, form a path 48 for the water to pass through the pump assembly.

As shown in FIG. 2c the water from the inlet spread out to the inlet check valves 36 under the effect of the suction created by the plunger mechanisms 40 which are provided in each pump assembly and which are moveable in a reciprocating linear manner as indicated by arrows 42 so as to allow water to be drawn into the inlet check valve 36 under vacuum and exit the outlet check valve 38 under pressure. The water which leaves the outlet check valve 38 of each of the pump assemblies, as indicated by arrows 44 in FIGS. 2d and h, is then combined and passes as indicated by arrow 50 in FIG. 2i to pass to the output 8 of the apparatus to form the high-pressure water flow which is dispensed from the apparatus. FIG. 2e illustrates the manner in which the water passing out of the inlet check valve 36 and then being pushed from the pump under pressure via the outlet check valve 38.

As shown in FIG. 2f the plunger mechanisms 40 create the suction needed to pass the water through the inlet and outlet check valves of the respective pump assemblies. The plunger mechanisms are moved to their respective positions in an offset sequence. FIGS. 2k and l and FIG. 5, mounted on the rotating shaft 35 of the motor along axis 34 there is provided a drive member 52 which includes a track formed so as to be eccentrically rotatable with respect to the rotating shaft 35 and is driven to rotate by the motor shaft within the cavity 54 of the pump and with which the pump assemblies 28,30,32 are in connection via respective bearings 60. The drive member 52 rotates along with the rotating motor shaft 35 and, as it does so, the same moves the plunger mechanisms 40 of the respective pump assemblies via engagement of the bearings 60 in the track so as to linearly move the plunger mechanism 40 of each pump assembly in a predefined sequence. Thus, at any given time, in accordance with one embodiment of the invention, one of the pump assemblies has its plunger mechanism 40 in a position so that the liquid therein is under pressure so as to emit the high-pressure water from its outlet check valve and the other two pump assemblies are under vacuum so as to draw water from the water supply to the pump into the inlet check valves of the respective assemblies and the condition of the respective pump assemblies change as the rotation of the drive member occurs so that the pump assemblies emit high pressure water therefrom in sequence This sequence of operation is repeated for each revolution of the drive means.

The drive member track has points of contact with the respective plunger mechanisms bearings 60, and the points of contact of the track are formed, similar to a cup and which has an outer ring surface 56 to push the plunger mechanisms 42 outwardly away from the shaft and an inner engagement wall 58 which engages with the said plunger mechanisms and as the track rotates, the relative position of the bearings 60 with respect to their plunger mechanism act to draw the plunger mechanisms inwardly or push the same outwardly depending on the position of the bearing on the track at that time. It will be appreciated that the shaping of the drive member 52, inner engagement wall 58, outer ring surface 56 and the degree of eccentric mounting of the drive means 52 on the shaft 35 are all selected so that in combination the same allow the required control of the sequence of operation of the respective pump assemblies and so as to provide a substantially continuous supply of higher pressure water from the respective pump assemblies and which then combine as indicated by arrows 43 of FIG. 2g to then leave from the pump as indicated by the arrow 50 as a combined pressurised flow to the outlet 8. Typically the pump includes an outer cover at the side of the pump at which the water enters and leaves the pump, as shown in FIG. 2i and which is not shown in certain other of the Figures for ease of illustration.

FIGS. 3a and b illustrate two possible bearing assemblies which can be provided at the end of the plunger mechanism 40. In FIG. 3a there is shown the end of the plunger mechanism with a recess 74 to one side of the same and in which is located the bearing 60. Alternatively and perhaps most suited to embodiments of the apparatus which are provided to allow a relatively high pressure water supply to be provided, the embodiment shown in FIG. 3b can be used in which the end of the plunger mechanism is provided with recesses 74,74′ on opposing sides of the mechanism 40 and into which recesses respective bearings 60, 60′ are located.

The movement of the valve seats within the respective inlet and outlet check valves, is as a result of the creation of the pressure and vacuum and springs can be provided to act on the seats so as to act as a failsafe mechanism should there be a malfunction and the pressure or vacuum increases beyond a certain limit. Thus, it will be appreciated that the movement of the valve seats in the inlet and the outlet check valves, are as a result of the creation of the vacuum or pressure by the plunger mechanism 40 with which the respective inlet and outlet check valves are associated and, that each assembly operates in sequence but independently from the other assemblies. The views of FIGS. 4a-i illustrate one embodiment of a valve seat 62 which is located in the inlet and outlet check valves 36, 38 and it will be seen that the seat 62 is provided with a series of legs 64 which define a cross shaped recess 66 at one side and three spaced apart leg members 68 on the opposing side of the seat. The legs 64, 68 and outer surface 70 of the seat act to guide the movement of the seat linearly along the respective check valve with the outer wall 70 contacting the inner side walls of the check valve.

With apparatus of this type there can be problems of leakage of liquid through the apparatus when the same is not being used but is still connected to the water supply and in particular a mains water supply which has some degree of pressure. In order to address this problem, in one embodiment, and typically located downstream 72 of, and in the output flow from, the pump there is provided a safety valve which is controlled to operate at a pressure above the pressure of mains water at the input. This means that when the liquid in the apparatus is not being acted upon by the operation of the pump the safety valve is shut and thereby prevents the flow of the liquid through the output of the apparatus. However when the pump is activated and the pressure of the water increases so the safety valve is opened and the pressurised water is supplied from the apparatus.

There can also be concerns with apparatus of this type which can produce relatively high pressure liquid therefrom and the potential risk to safety of users and/or bystanders due to incorrect use of the apparatus and/or unauthorised adaptation of the apparatus. In order to prevent or minimise this risk there is, in one embodiment, provided in the pressurised water output downstream 72 from the pump, a limiter assembly which in one embodiment includes a switch which is capable of operating and over riding manual control of the control means of the apparatus so as to switch off the motor and hence pump should a valve provided with the limiter assembly be closed by the pressure of the water from the pump reaching a predetermined pressure value at which the valve is set to close. If the valve is closed, the switch is activated and the motor and pump switched off and thereby the creation of the excessive pressure level of water to be emitted from the apparatus is prevented.

Referring now to FIG. 6 there is illustrated apparatus 102 in accordance with an embodiment of the invention in which the same is provided as a portable pressure washer apparatus, with a portable power supply in the form of battery pack although it should be appreciated that the invention as herein described, can be utilised in conjunction with apparatus which is provided for connection to a mains electricity supply and a mains water supply.

The apparatus housing 104 has an input 106 and leads to a wand portion 107 which has an output 108. The input 106 is provided to be connected to a source of liquid which in accordance with all of the embodiments most typically will be water but could other liquids which are desired to be applied under pressure. When the liquid is water the same can be water from a mains source, a container directly connected to the housing or via a pipe to allow water to be drawn from the container and into the input 106.

At the output 108, there may be provided means 109 to allow the user to adjust the particular form which the liquid is output such as, for example, a selection can be made between providing the output of the water in a spray pattern, a single stream or different types intermediate of the same.

Also providing in the housing are mechanical engagement means 110 which are provided to allow the mechanical engagement with the housing of a battery pack 112 as shown. The battery pack can be of any appropriate form and typically, is provided with, in a conventional manner, a series of terminals which when the battery pack is mechanically engagement with the housing, allow electrical contact to be made with terminals provided on the housing.

When the power cells and the battery pack are charged and the battery pack is mechanically connected to the housing, so power supply is provided for operation of the apparatus from the battery pack. Also provided in this housing, are user actuation means 116 to allow the user to switch the apparatus on and off by a pivotal movement of, in this embodiment, user actuation means in the form of a lever or handle about the pivot axis 115. When the handle is moved to the on position, this operates an electrical switch in the housing to connect power from the battery pack to operate a motor 120 and pump 122 and hence the generation of the output of water at a higher pressure from the output 108 than that at which it enters the apparatus at the input 106.

The handle portion is typically mounted adjacent to a gripping portion 118 via which the user can direct the housing and hence the flow of pressurised water therefrom onto a particular article to clean the same.

Also provided in the housing, is a control means 114 which is typically moveable along an axis between first and second positions. When in the unlocked position, the user actuation means 116 can be operated to allow the same to be pivotally moved between the on and off positions. When the control means is in a locking position, then the same engages with the user actuation means to retain the same in an on or off position.

Referring now to FIG. 7, there is illustrated in a schematic manner, the flow path of the liquid from the input 106 to the output 108 and as the liquid leaves the input 106 and moves as indicated by arrow 125, it moves towards a check assembly 128. When a check valve 140 provided in the check assembly is open, the water enters the pump 122, is pressurised and then passes towards the output 108. If the check valve 140 is closed, then the water that enters the input 106, is prevented from moving any further along the flow path than the check assembly 128 and this therefore prevents the passage of water through the apparatus in an unpressurised manner which would otherwise occur if the check assembly was not present and such a circumstance could arise if, for example, the mains water supply was turned on but the pump and motor were switched off. It will therefore be appreciated that in order for the apparatus to be operated to supply the pressurised water, the check valve 140 of the assembly 128 needs to be opened at the appropriate time. One assembly for doing so is illustrated in FIGS. 8a and b.

In accordance with the invention, the control means 114 provided in the apparatus, are located with an external portion 130 to allow user movement of the same between the first position shown in FIG. 8a and the second position shown in FIG. 8b. In one embodiment when the external portion 130 is in the position shown in FIG. 8a the same acts on rotatable member 132 which, at the opposing end, is in contact with the handle 116. It also is connected to member 134 which in FIG. 8a, has its free end being acted upon by spring 136 so that it is exerting no movement pressure on the movable portion 138 of the check valve 140 which is mounted downstream of the input 106. In the position shown in FIG. 8a no liquid is therefore able to pass through the check valve 140 and reach the pump 122 which is switched off so that the flow of the input unpressurised liquid through the apparatus is prevented.

When the user wishes to move the apparatus to an on condition they exert a movement force on the external portion 130 to move the same as indicated by arrow 142 to move the same against the biasing force of the spring 144 to the position shown in FIG. 8b. In turn, this frees the opposing end 146 of the rotatable member 132 and allows the user actuation means handle 116 to be moved by the user as indicated by arrow 148 to the position shown in FIG. 8b and, at the same time, operate the switch 150 and therefore turn the apparatus on. At the same time the member 134 is moved in the direction of arrow 152 by the movement of the rotatable member 132 to act against the spring and move the movable portion 138 of the check valve 140 inwardly of the check valve to move the same to an open position and hence allow the movement of the liquid through the input 106, check valve 140, check assembly 128 and onwardly to the pump 122 which is switched on.

When the handle 116 is moved back to the off position shown in FIG. 8a the spring 144 acts to move the external portion 130 back to the position of FIG. 8a and in turn the rotatable member 132 moves the member 134 back to the position shown in FIG. 8a to close the check valve 140.

Thus, there is provided in accordance with this embodiment of the invention, a check valve assembly to allow the operation of the check valve to an open position as and when required to allow the flow of liquid through the apparatus to be pressurised. Typically, when the control means are released, and at the same time, are released from contact with the valve seat, so a biasing means in the check valve will cause the movable portion 38 to return to a closed position and retain the same in that closed position until the control means are again used.

It is known that the viscosity of water can change as a direct result of the temperature in the environment in which the water is located. Furthermore, this temperature change can be as a result of the operation of apparatus in the vicinity of the water so that the heat generated by the operation of the apparatus is transferred to the water.

In turn, the change in heat and hence viscosity of the water, can also affect the performance of apparatus, which is used to, for example, pump the water as in accordance with the pump of the current apparatus.

In accordance with the invention, there is therefore provided a means of identifying and monitoring at least one parameter which is representative of, or can be used to calculate, the viscosity of water which is present or passing through the apparatus. In one embodiment, as result of the determination of the viscosity of the water in the pump at that time, and the effect of the viscosity of the water on the operation of the pump, control means can be provided to allow the particular operation of the pump at an instant of time to be adjusted to take into account the viscosity of the water and thereby provide a means of reacting to the feedback data which is received during operation of the apparatus.

In a further embodiment of the invention, the same or additional or alternative data which is fed back from the operation of the apparatus, can be used to alter the operation of the pump and/or other components of the apparatus such as, for example, a means of determining the level of charge in the battery pack which is used to operate the apparatus can be used so as to alter the operation of the apparatus as it is known that the pressure of water which can be achieved from the pump in the apparatus, will, unless modification to the operation of the apparatus is performed, reduce as a result of charge being lost in the battery pack during operation of the apparatus.

In one embodiment, the data includes the monitoring of the current in the battery pack and an adjustment can be made to the speed of operation of the pump.

In one embodiment, the motor which is used in the apparatus to operate the pump, is a brushless motor and furthermore, can be provided as an out runner brushless motor in that the central core is stationary and is surrounding outrider spins around the core or spindle.

It is found that this arrangement of a brushless motor, is advantageous in allowing the waterproofing or sealing of the apparatus so as to prevent or minimise the ingress of water into components of the apparatus such as electrical or electronic components for the control means so that the electrical or electronic components can be provided in a sealed compartment and the brushless motor itself, can be provided in another part of the housing or even in a separate housing to thereby be, exposed to water without adversely affecting the operation of the apparatus. In one embodiment, the exposure to water is deliberate in order to allow the water to provide a cooling effect on the motor as it performs and thereby prevent the same from overheating.

In one embodiment, preformed passageways for the flow of water in a controlled manner with respect to the motor, can be provided to thereby allow the desired cooling effect to be achieved and, furthermore, the placement of the apparatus into a body of water perhaps deliberately to fill a container from which water is to be pressurised, or in error due to accidental dropping of the apparatus, will not have an adverse effect on the operation of the apparatus.

In one embodiment, the battery pack, when located on receiving means on the apparatus body, is received into a compartment which, when the battery pack is in a mechanically and electrically located position, can be sealed so as to provide and retain the battery pack and in particular the interface between the battery pack and the remainder of the apparatus, to be retained in a sealed waterproof condition.

In one embodiment, the compartment is provided with a hinged or otherwise engageable lid which can be removed to allow the battery pack to be placed into and removed from the interface and a closed position to provide the seal around the lid and the body of the compartment to prevent the ingress of water into the compartment during use of the apparatus.

In one embodiment, it should be appreciated that although the apparatus diagrams as herein described, illustrate the use of a pump with three pump assemblies radially spaced around the central axis, the apparatus can be provided in other forms such as, for example, five pump assemblies are provided radially equally spaced around the central axis or more or even fewer pump assemblies may be provided and the adaptation of the same can be to provide a required operating characteristic of the particular version of the apparatus.

There is therefore created in accordance with the invention, apparatus which allows the water, which is input into the same, to be output from the same at a significantly greater pressure than that at which it enters. Furthermore, it is found by the use of pump as herein described, the difference in the pressure from the input to the output, is significantly greater than that which can be achieved by other portable apparatus and, as such, makes the practical usage of the apparatus in accordance with the invention such as to create a commercially viable product.

What is claimed is:

1. Pressure washer apparatus, said apparatus including an input for connection to a source of a liquid, an output from which the said liquid leaves the apparatus, when operating, at a pressure greater than that which it enters the apparatus, a power supply to the said apparatus to operate a motor and in turn operate a pump, said pump located intermediate the said input and output and through which the liquid passes and wherein said pump includes a plurality of pump assemblies which are angularly offset about a drive axis.

2. Apparatus according to claim 1 wherein each of the pump assemblies includes a plunger mechanism provided for linear movement along a respective axis and the axes of the respective plunger assemblies are substantially perpendicular to the axis of a channel along which the liquid flows from the pump to the output.

3. (canceled)

4. Apparatus according to claim 1 wherein each pump assembly includes an inlet check valve so as to allow liquid to enter from a common chamber which is supplied with liquid from the said input and an outlet check valve to allow leave and be combined downstream of the outlet valves, and pass along at least one channel to the output of the apparatus.

5-7. (canceled)

8. Apparatus according to claim 1 wherein there is provided a rotatable drive shaft mounted along the said drive axis and driven to rotate by the motor which is provided in the housing and connected to said power supply a drive member including a track is provided which has a centre which is offset to the said drive axis and about which drive axis the drive member rotates so as to move the said plunger mechanisms of the respective assemblies in a sequential manner.

9. (canceled)

10. Apparatus according to claim 1 wherein the motor, pump, input and output are all located within a common housing which includes at least one power supply means connected therewith and the said power supply means are selectively locatable with the housing and carried thereby during operation of the apparatus.

11-12. (canceled)

13. Apparatus according to claim 1 wherein the source of liquid supply is a container in which water is held or a mains water supply and/or a source for a cleaning media to be added to the water.

14. (canceled)

15. Apparatus according to claim 1 wherein the pump includes an inlet chamber and an outlet chamber, a chamber communicating the inlet chamber and the outlet chamber, each pump assembly including an inlet valve connected to the inlet chamber, an outlet valve connected to the outlet chamber and a plunger mechanism, and a drive member located on the drive axis, said drive member including an eccentrically mounted track such that when the drive member rotates the track pushes the plunger mechanisms individually and in sequence away from the drive axis and returns the plunger mechanisms individually and in sequence via a bearing located with the track.

16. Apparatus according to claim 15 wherein in each pump assembly the outlet valve is driven by the inner engaging wall of the drive member while the inlet valves are driven by the respective plunger mechanism and the eccentric outer ring.

17. Apparatus according to claim 15 wherein the plunger mechanisms are provided with at least one bearing located in the track of the drive member so as to move in an eccentric path with respect to the drive axis.

18: Apparatus according to claim 17 wherein the plunger assemblies are in contact with the eccentric member track via one or more rotatable bearings and each plunger mechanism is provided with a contact slot connected with the eccentric moving cup.

19. Apparatus according to claim 1 wherein the plunger mechanism consists of at least two different materials in order to adjust the weight of the plunger mechanisms to reduce overall vibration of the apparatus.

20. (canceled)

21. Apparatus according to claim 15 wherein the outlet chamber is connected to a pressure valve which prevents liquid from flowing through the apparatus when the pump is not activated.

22. Apparatus according to claim 1 wherein the motor connected to the drive shaft is selectively operable at different speeds to regulate the pressure and the flow of liquid from the outlet of the pump.

23. Apparatus according to claim 15 wherein the pump assembly is suspended from the inner walls of the housing so as to dampen vibration caused by operation of the pump.

24. (canceled)

25. Apparatus according to claim 1 wherein there is provided a component intermediate the motor and the pump to pass at least a portion of the input liquid past the motor to provide a cooling effect on the motor during operation of the apparatus.

26. Apparatus according to claim 1 wherein the apparatus includes a user actuable means to allow the selective change of the apparatus between on and off conditions and wherein at least one check valve assembly is provided in the flow path of the liquid between the input and the output and the operation of the check valve assembly between closed and open positions is achieved by the movement of control means between first and second positions.

27-28. (canceled)

29. Apparatus according to claim 26 wherein the control means are connected to a member of the check valve assembly which exerts a movement force on a valve seat of the check valve to move the same to an open position when the control means is moved to the second position.

30. Apparatus according to any of the claim 26 wherein the check valve includes biasing means which, when the control means is moved from the second position, causes the valve seat to be returned to a closed position automatically and without the need for user actuation of the control means.

31. Apparatus according to claim 26 wherein the valve seat and control means are arranged so that the valve seat is moved to the open position when the control means is moved to a second position in which the same also acts to lock the user actuation means.

32. Apparatus according to claim 26 wherein when the user actuation means are in the on condition and the check valve is in the open position the motor and pump are operated to pressurise the said liquid before it leaves the output.

33. (canceled)

34. Apparatus according to any of the claim 26 wherein the control means includes a portion which is located with respect to the user actuation means so that when the control means is moved to a locking position the user actuation means is retained in position.

35. Apparatus according to claim 1 wherein the apparatus includes temperature sensing means to detect the temperature of the liquid at the input, means to communicate data relating to said temperature to control means for the operation of the apparatus, a database which links the viscosity of the liquid to the detected temperature and adjustment means to adjust the speed of the motor and/or pump to thereby control the pressure of the liquid emitted from the output of the apparatus.

36. (canceled)

37. Apparatus according to claim 1 wherein the voltage of the power source is monitored during operation of the apparatus and as the voltage level drops the speed of operation of the motor is adjusted so as to maintain a substantially uniform speed of operation of the pump and hence pressure of liquid from the output.

38. Pressure washer apparatus including a housing in which there is provided a pump which includes an inlet chamber into which a liquid is supplied and an outlet chamber, a chamber communicating the inlet chamber and the outlet chamber, a plurality of pump assemblies, each said pump assembly including an inlet valve connected to the inlet chamber, an outlet valve connected to the outlet chamber and a plunger mechanism, a drive member located on a drive axis, said drive member including an eccentrically mounted track such that when the drive member rotates the track pushes the plunger mechanisms individually and in sequence away from the drive axis and returns the plunger mechanisms individually and in sequence via a bearing located with the track so as to operate the said pump assemblies in sequence and create an output of liquid at a greater pressure when emitted from an output of said apparatus than when the said liquid is supplied into the inlet chamber.
